(19) United States
(12) Patent Application Publication
(10) Pub. No.: US 2024/0113393 A1
(43) Pub. Date: Apr. 4, 2024

(54) PROTECTIVE COATINGS FOR LITHIUM METAL ANODES INCLUDING EDGES

(71) Applicant: Sakuu Corporation, San Jose, CA (US)

(72) Inventors: Tara FOROOZAN, San Jose, CA (US); Ali MODJTAHEDI, San Jose, CA (US); Joykumar THOKCHOM, San Jose, CA (US); Aditya UPRETI, San Jose, CA (US); Bobak BAGHERI, San Jose, CA (US); Micheal GUO, San Jose, CA (US); Steven Zhichao SHI, San Jose, CA (US); Arwed NIESTROJ, San Jose, CA (US)

(73) Assignee: Sakuu Corporation, San Jose, CA (US)

(21) Appl. No.: 18/470,600

(22) Filed: Sep. 20, 2023

Related U.S. Application Data
(63) Continuation-in-part of application No. 17/959,893, filed on Oct. 4, 2022.

(51) Int. Cl. H01M 50/451; H01M 4/134; H01M 4/1395; H01M 10/0525; H01M 10/0565; H01M 50/403

(52) U.S. Cl. CPC H01M 50/451; H01M 4/134; H01M 4/1395; H01M 10/0525; H01M 10/0565; H01M 50/403

(57) ABSTRACT

A lithium cell for a lithium metal battery includes: an electrolyte material; a cathode structure arranged on one side of the electrolyte material, the cathode structure including a cathode electrode and a cathode current collector; and an anode structure arranged on an opposite side of the electrolyte material from the cathode structure. The anode structure includes: an anode current collector; a lithium metal anode arranged on a side of the anode current collector arranged facing the electrolyte material; and a protective coating deposited on a surface of the lithium metal anode and arranged facing the electrolyte material, wherein the protective coating extends beyond the lithium metal anode and onto the anode current collector so as to seal both a surface and edge regions of the lithium metal anode from contact with a liquid electrolyte of the electrolyte material.

### RELATED APPLICATIONS

The present application is a continuation-in-part and claims the priority of U.S. patent application Ser. No. 17/959,893, filed 4 Oct. 2022, which is incorporated herein by reference in its entirety.

### TECHNICAL FIELD

The present disclosure relates generally to lithium metal batteries, and, in particular, to systems and methods for protecting lithium metal anodes of lithium metal batteries.

### BACKGROUND

Rechargeable lithium metal batteries have superior electrochemical capacity and high operating voltage, thus high energy density. Demand for lithium metal batteries is increasing in the fields of portable information terminals, portable electronic devices, small power storage devices for home use, motorcycles, electric cars, hybrid electric cars, and the like. Hence, improvements to the performance and the safety of lithium metal batteries are desired in response to the increasing demand.

A lithium metal battery typically includes an anode and a cathode separated by an electrically insulating barrier or separator. The separator includes an electrolyte medium that typically includes one or more lithium salts and one or more organic carbonate solvents with additional additives. During the charging process, the positively charged lithium ions move from the cathode, through the liquid electrolyte soaked/wetted permeable separator, to the anode and reduce into Li metal. During discharge, the Li metal is oxidized to positively charged lithium ions. The lithium ions move from the anode, through the liquid electrolyte soaked/wetted permeable separator, and back to the cathode, while electrons move through an external load from the anode to the cathode, yielding current and providing power for the load.

Conventional lithium-ion batteries use a graphite anode. Such batteries are reaching their theoretical performance capacity, leaving little room for improvement. Consequently, to further increase the energy density performance of lithium-ion batteries, research is ongoing into lithium metal batteries that use a lithium metal as the anode.

However, the use of lithium metal in rechargeable batteries poses several major concerns. First, when a lithium-metal battery discharges, electrons move through an external load from the anode. Simultaneously, lithium ions separate from the surface/de-plate of the anode and travel to the cathode. When the battery is charged, the lithium ions travel back and deposit/plate onto the anode as lithium metal. But, instead of forming a nice smooth plated layer on the anode, lithium metal has the tendency to generate “dendrites” or chains of lithium atoms that look like tree roots growing from the surface of the anode. These dendrites grow bigger with each charge-discharge cycle, eventually reaching the cathode and causing the battery to short. This leads to battery failure and potential thermal runway and fires.

Second, lithium metal is highly reactive, which means it suffers side reactions with the battery's liquid electrolyte. These undesirable reactions reduce the amount of lithium available and shorten the battery's life with every charge-discharge cycle.

Third, lithium batteries may suffer from low Coulombic efficiency (CE). This is due to the parasitic reactions between lithium and electrolyte that form undesirable solid electrolyte interphase (SEI). This leads to the continuous loss of lithium over the life of the battery and increased resistance associated with electrolyte consumption until the battery eventually fails.

Time and effort have gone into identifying suitable lithium metal anode protection technologies for alleviating the issues mentioned above. However, for various reasons, an effective protection technology has yet to be developed that can lower Li-electrolyte interface resistance to make the interface stable and increase cycle efficiency of metallic Li to extend the cycle life of the battery.

### SUMMARY

In one general aspect, the instant disclosure presents a lithium cell for a lithium metal battery includes: an electrolyte material; a cathode structure arranged on one side of the electrolyte material, the cathode structure including a cathode electrode and a cathode current collector; and an anode structure arranged on an opposite side of the electrolyte material from the cathode structure. The anode structure includes: an anode current collector; a lithium metal anode arranged on a side of the anode current collector arranged facing the electrolyte material; and a protective coating deposited on a surface of the lithium metal anode and arranged facing the electrolyte material, wherein the protective coating extends beyond the lithium metal anode and onto the anode current collector so as to seal both a surface and edge regions of the lithium metal anode from contact with a liquid electrolyte of the electrolyte material.

In another general aspect, the instant disclosure presents a method of providing a protective coating on a lithium metal anode includes: forming a lithium anode electrode on an anode current collector, the anode current collector being a substrate providing support for the lithium anode electrode; and forming a protective coating over the lithium anode electrode, the protective coating extending beyond edges of the lithium anode electrode and onto surrounding portions of the anode current collector. Both edge and surface regions of the lithium anode electrode are covered by the protective coating to prevent contact with a liquid electrolyte.

In another general aspect, the instant disclosure presents a method of providing a protective coating on a lithium metal anode includes: forming a lithium anode electrode on an anode current collector, the anode current collector being a substrate providing support for the lithium anode electrode; and using a selective deposition additive manufacturing system, depositing a protective coating over the lithium anode electrode according to an electronic data model of the coating, the protective coating extending beyond edges of the lithium anode electrode and onto surrounding portions of the anode current collector Both edge and surface regions of the lithium anode electrode are covered by the protective coating to prevent contact with a liquid electrolyte.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 shows an example of a lithium metal battery cell including a lithium metal anode and a protective coating for the lithium metal anode in accordance with this disclosure.

FIG. 2 shows a cathode structure of the lithium metal cell of FIG. 1.

FIG. 3 shows the anode structure of the lithium metal cell of FIG. 1.

FIG. 4 shows a flowchart of an example method for providing a nanoceramic protective coating on the anode structure of FIG. 3.

FIGS. 5A-5E show examples of anode structures including multiple layers of protective coatings.

FIG. 6 shows the anode structure of FIG. 5 assembled to form a lithium metal battery cell.

FIG. 7 shows a flowchart of an example method for providing a composite polymer electrolyte protective coating on the anode structure of FIG. 3.

FIGS. 8A-8D are images illustrating use of a protective coating on a lithium anode electrode. FIGS. 8B-8D specifically illustrate an edge region of the protective coating where some of the lithium of the anode electrode is exposed to liquid electrolyte.

FIGS. 9A-9D depict an anode structure according to principles described herein to prevent unwanted dendrite formation at edges of a lithium anode electrode.

FIGS. 9E-9G additionally depict anode structures according to principles described herein to prevent unwanted dendrite formation at edges of a lithium anode electrode.

FIGS. 10A-10C are flowcharts depicting methods used for forming the fully-protected anode electrode described herein.

FIGS. 11A and 11B illustrate example lithium metal cells according to principles described herein.

FIGS. 12A-12B and 13A-13B illustrate examples of using a patterned lithium anode to enhance the adhesion of the protective coating for a lithium metal anode according to principles described herein.

### DESCRIPTION

In the following detailed description, numerous specific details are set forth by way of examples to provide a thorough understanding of the disclosed subject matter. It may become apparent to persons of ordinary skill in the art, though, upon reading this disclosure, that one or more disclosed aspects may be practiced without such details. In addition, description of various example implementations according to this disclosure may include referencing of or to one or more known techniques or operations, and such referencing can be at relatively high-level, to avoid obscuring of various concepts, aspects and features thereof with details not particular to and not necessary for fully understanding the present disclosure.

In accordance with this disclosure, protective coatings for coating lithium metal anodes are provided. The protective coatings comprise polymeric, ionically conductive composite materials which may or may not include inorganic particles and various other materials in different formulations for imparting desired characteristics to the coatings and that enable the coatings to be adhered/affixed to a surface of the lithium metal anode, such as by slurry coating and curing using an ultraviolet light (UV) curing process, natural or forced convection or IR solvent drying, sputtering or evaporation (PVD), chemical vapor deposition (CVD), or various combinations of these, depending on the composition of the coating. The protective coatings described below include polymer nanoceramic (referred to herein as “nanoceramic”) protective coatings, polymer and gel-polymer electrolyte protective coatings, pure ceramic protective coatings, and lithium alloy protective coatings. These coatings may be used alone or in combination with each other and/or with other types of a protective layer on lithium metal anodes to prevent the lithium anode surface from directly contacting liquid electrolyte and to limit undesired side reactions, such as dendrite formation and unwanted consumption of the liquid electrolyte. The protective coatings may also improve mechanical and thermal stability and improve ionic conductivity while also protecting from lithium consumption and overall safety of the battery.

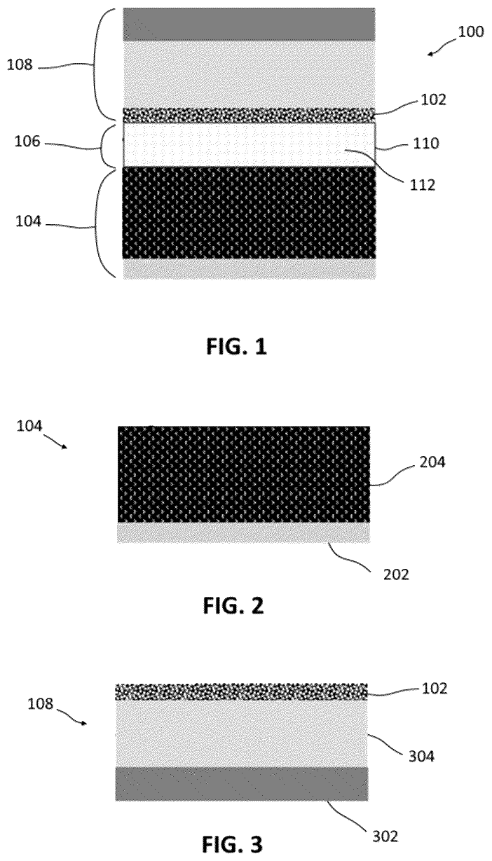

FIG. 1 shows an example of a lithium metal cell 100 for a battery including a protective coating 102 in accordance with this disclosure. As used herein, a “battery” refers to any structure in which chemical energy is converted into electricity to be used as a source of power. The terms “battery” and “cell” are generally interchangeable when referring to one electrochemical cell, although the term “battery” can also be used to refer to a plurality or stack of electrically interconnected cells. The lithium cell 100 of FIG. 1 includes a cathode structure 104, an electrolyte region 106, and an anode structure 108.

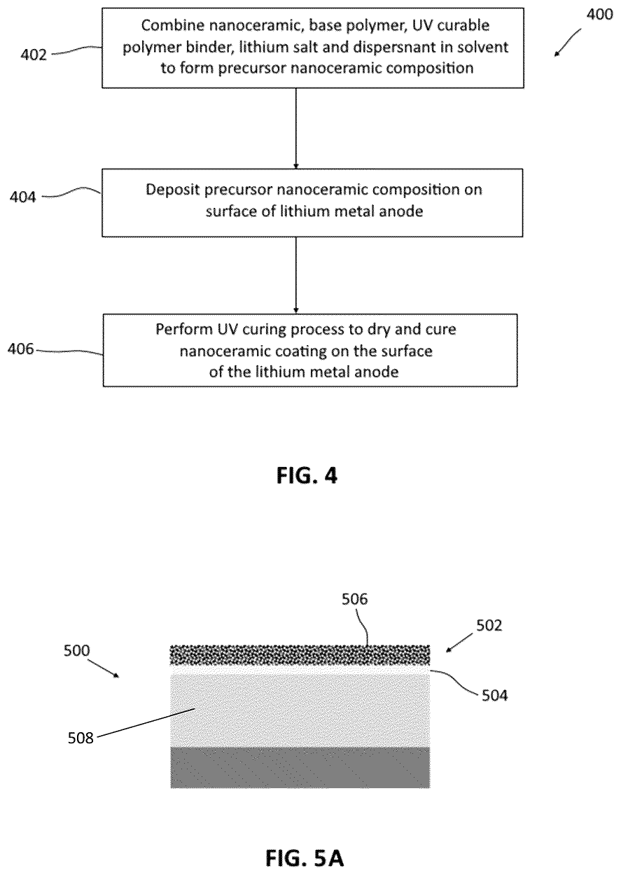

Referring now to FIG. 2, the cathode structure 104 includes a cathode current collector 202 (also referred to herein as a positive current collector) and a cathode electrode 204. The cathode current collector 202 may be in the form of a plate, sheet, foil, cloth, and the like formed of a suitable conductive material. Examples of materials that may be used to form the cathode current collector 202 include aluminum, stainless steel (with or without a thin carbon coating), titanium, other metal coated with polymer sheet (e.g. polyimide), carbon fiber, carbon sheet/paper, conductive polymer, other polymer-based materials, and the like. The cathode current collector 202 may be formed in any suitable manner and have any suitable thickness. In various examples, the cathode current collector 202 has a thickness in a range from 5-30 microns. In one particular example, the cathode current collector 202 has a thickness of 12 microns.

The cathode electrode 204 is formed of a suitable cathode active material. For example, the cathode electrode 204 may be formed of a spinel and layered cathode active material. Examples of materials that may be used in the cathode electrode include lithium iron phosphate (LFP), lithium manganese iron phosphate (LMFP), lithium cobalt oxide (LCO), lithium manganese oxide (LMO), lithium nickel cobalt aluminum oxide (NCA), lithium nickel cobalt manganese aluminum oxide (NCMA), lithium nickel manganese cobalt oxide (NMC) and all its variants, lithium nickel manganese oxide (LMNO), Li-rich cathodes, and combinations of these. The cathode current collector 202 may be used as a substrate and mechanical support for the cathode electrode 204. The cathode electrode 204 is provided on the surface of the collector 202 that is intended to face the electrolyte region 106.

The cathode electrode 204 may be formed on the cathode current collector 202 in any suitable manner. As an example, a cathode active material may be mixed with a conductive additive, or conductivity promoting agent, and a binder material which is coated onto the surface of the cathode current collector 202. Examples of conductive additives that may be used include carbon nanotube (CNT), carbon black, acetylene black, Ketjen black, carbon nanofibers (CNFs), vapor-grown carbon fibers (VGCFs), graphene, conductive metals, alloy powders, and various combinations of these. Examples of binder materials that may be used include polyvinylidene difluoride (PVDF), poly(vinylidene fluoride)-co-hexafluoropropylene (PVDF-HFP), and polytetrafluoroethylene (PTFE). In various examples, the cathode active material may be infused with an ionic liquid and/or one or more lithium salts. Any suitable ionic liquid and/or lithium salt may be utilized.

In various examples, the cathode active material, conductive additive, and binder material may be dispersed in a suitable solvent material to form a suspension, or slurry, that is coated onto the surface of the cathode current collector 202. The solvent may then be removed from the suspension, leaving a thin-plate-like electrode 204. In various examples, a calendaring process may be utilized to compress the cathode material and the collector together to achieve a desired level of porosity and/or thickness for the cathode material 204. Any suitable porosity and/or thickness for the cathode electrode may be selected. In various examples, the cathode electrode may have a porosity in a range 10%-45% and a thickness in a range of 20-120 microns after calendering.

Referring to FIG. 1, the electrolyte region 106 includes a separator 110 that contains an electrolyte material 112. The separator 110 is a permeable membrane placed between the cathode structure 104 and anode structure 108 primarily to prevent short circuits while also allowing the transport of lithium ions. The separator 110 may be formed of any suitable material. Examples of materials that may be used in the separator 110 include porous single layer polypropylene (PP) or polyethylene (PE), or multilayer polypropylene-polyethylene (e.g., dual layer PP-PE, trilayer PP-PE-PP), nylon or cellophane, PET, PET/PP, cellulose, glass fiber, polyamide, and PVDF and its variants. In various examples, the separator 110 may include a surfactant and/or ceramic coating on one or both sides of the separator. In various examples, the separator 110 comprises a trilayer PP-PE-PP with a ceramic coating on one or both sides with or without an additional surfactant coating. The separator 110 may have any suitable porosity and thickness. In various examples, the separator 110 may be provided with a porosity in a range from 0%-80% and a thickness in a range from 5-100 microns. In various examples, the protective coating 102 for the anode structure 108 may be used as the separator for the lithium cell such that a porous separator, such as separator 110, may be omitted. In various examples, the separator and/or the liquid electrolyte may be omitted, such as in solid-state batteries.

In various examples, the electrolyte material 112 may comprise a liquid electrolyte material that is soaked into the separator 110. Any lithium stable liquid electrolyte or ionic liquid electrolyte may be utilized. The liquid electrolyte may include one or more lithium salts, such as lithium bis(trifluoromethanesulfonyl)imide (LiTFSI), lithium (flurorosulfonyl) (trifluoromethanesulfonyl)imide (LiFTFSI), lithium bis(fluorosulfonyl) imide (LiFSI), lithium bis(perfluoroethanesulfonyl)imide (LiBETI), lithium hexafluorophosphate (LiPF₆), lithium tetrafluoroborate (LiFB₄), lithium bis(fluorosulfonyl)amide (LiFSA), lithium bis(trifluoromethanesulfonyl)amide (LiTFSA), lithium bis(oxalato)-borate (LiBOB), lithium difluoro(oxalato)borate (LiDFOB), lithium fluoride (LiF), lithium nitrate (LiNO₃), or any lithium salt that dissociates into cation and anion responsible for ionic conduction. The liquid electrolyte may also include one or more organic solvents, such as propylene carbonate (PC), dimethoxyethane (DME), dioxolane (DOL), trimethyl phosphate (TMP), triethyl phosphate (TEP), vinylene carbonate (VC), fluoroethylene carbonate (FEC), bis(2,2,2-trifluoroethyl) ether (BTFE), tetrafluoropropylether (TTE), tris(2,2,2-trifluoroethyl)phosphate (TFEP), dimethyl carbonate (DMC), ethyl-methyl carbonate (EMC), and the like. In various examples, the liquid electrolyte may include one or more ionic liquids with one or more lithium salts. Any suitable ionic liquid and lithium salt may be utilized. In other examples, other types of electrolyte materials may be used including solid and/or hybrid electrolyte materials. In various examples, the electrolyte material 112 may include multiple types of electrolyte, e.g., solid, hybrid, and liquid, which are provided in layers of the separator 110 between the cathode structure 104 and anode structure 108.

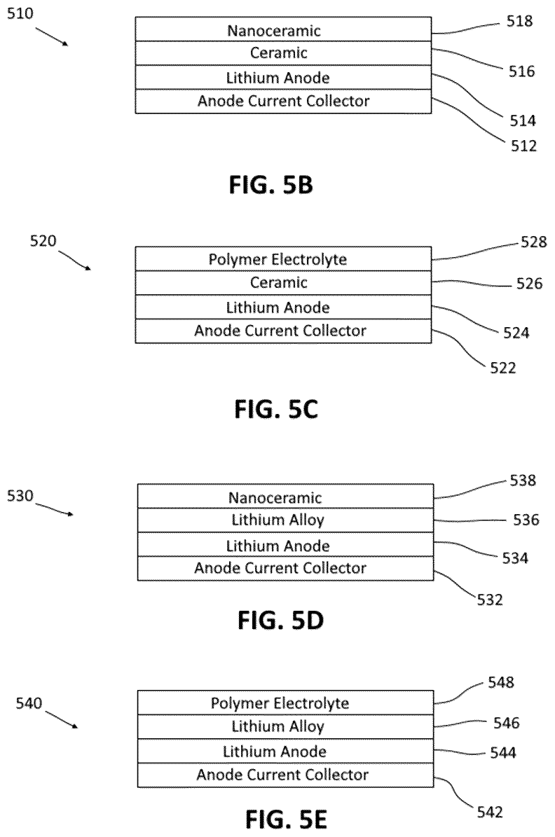

Referring now to FIG. 3, the anode structure 108 of the lithium metal cell of FIG. 1 includes an anode current collector 302 (also referred to as a negative current collector), a lithium metal anode 304 (i.e., anode electrode), and a protective coating 102 that has been applied to the lithium metal anode 304. The anode current collector 302 may be in the form of a plate, sheet, foil, cloth, and the like formed of a suitable conductive material. Examples of materials that may be used to form the anode current collector 302 include copper, copper foil, electrodeposited copper foil, copper alloy foil, nickel foil, electrodeposited nickel foil, stainless steel foil, metal coated with polymer sheet (e.g. copper coated with polyimide), carbon sheet/paper, and electronically conducting polymer sheet. The anode current collector 302 may be formed in any suitable manner and have any suitable thickness. In various examples, the anode current collector 302 is provided with a thickness in a range from 5-30 microns. In one particular example, the anode current collector 302 has a thickness of 8 microns.

The anode electrode 304 is formed of suitable lithium metal material, such as lithium foil. The lithium foil may comprise bare lithium foil, organically cleaned lithium foil, smooth or perforated lithium foil, pure (100%) ceramic nanolayer (LiF, Li₂O, Li₃N, Li₂CO₃, Li₃PO₄, LiPON, BN, MgF₂, SrF₂) directly formed coating or coated lithium foil, nanoceramic composite polymer coated lithium, graphene or CNT with or without Li salt, and binder coated Li foil. In various examples, the lithium foil is provided with a thickness in a range from 0.1 to 200 microns. In one particular example, the lithium foil is provided with a thickness of 20 microns. The anode current collector 302 may be used as a substrate and mechanical support for the anode electrode 304. The anode electrode 304 is provided on a surface of the anode current collector 302 intended to be arranged facing the electrolyte region 106.

In various examples, the lithium anode 304 may comprise a lithium alloy material, such as lithium-tin (Li—Sn), lithium-indium (Li—In), Lithium-Galium, lithium-silver (Li—Ag) and combinations of them. In these examples, the lithium alloy anode also serves as a protective coating which is more resistant to side reactions, such as dendrite formation and/or unstable SEI formation, than other lithium metal anodes. As described below, lithium alloy coatings may also be used as a protective coating that can be layered with other protective coating(s) to provide additional protection for the lithium anode.

The anode electrode 304 may be formed on the anode current collector 302 in any suitable manner. In various examples, lithium foil may be deposited onto the anode current collector 302 (e.g., copper foil) using a suitable thin film deposition technique or method. As examples, lithium foil may be laminated onto copper foil. Evaporation and sputtering techniques may be used as well. Lithium may also be screen printed onto the collector 302 using stabilized lithium powder as a slurry. In various examples, a calendaring process may be utilized to compress the anode electrode 304 to achieve a desired level of porosity and/or thickness for the anode electrode 304 after the screen printing and drying. In various examples, the lithium anode electrode 304 may have a thickness in a range from 0.1 to 200 microns.

In accordance with this disclosure, protective coatings for coating the lithium metal of the anode electrode (also referred to herein as “lithium metal anode”) are provided. In various examples, the protective coatings, such as nanoceramic coatings and polymer electrolyte coatings, comprise polymeric, ionically conductive composite materials including inorganic particles and various other materials in different formulations for imparting desired characteristics to the coatings and that enable the coatings to be adhered/affixed to a surface of the lithium metal anode, such as by using an ultraviolet light (UV) curing process. In various examples, non-polymeric protective coatings may be used, such as pure ceramic coatings and lithium alloy coatings. The protective coatings described below, such as nanoceramic protective coatings, polymer electrolyte protective coatings, ceramic protective coatings and lithium alloy coatings, may be provided as a single layer or multiple layers and may be used alone or in combination with each other and/or other types of protective coatings. The coatings may be non-porous in order to prevent the lithium anode surface from directly contacting liquid electrolyte and to limit undesired side reactions, such as dendrite formation and/or unstable SEI formation that can lead to unwanted consumption of the liquid electrolyte and Li metal itself. The protective coatings may also improve mechanical and thermal stability and improve ionic conductivity while also protecting from lithium consumption and promoting the overall safety of the battery.

A nanoceramic protective coating for the lithium metal anode includes inorganic particles in the form of nanoceramics. In various examples, the nanoceramics have a particle size in a range from 10-1000 nm, and in one particular example, have a particle size of approximately 100 nm. Nanoceramics may be ionically conductive or non-conductive. Examples of ionically conductive nanoceramics that may be used include lithium lanthanum zirconium oxide (LLZO) and its single or multiple cation doped variants (e.g., tantalum doped LLZO and Ga, Nb or Mg, Sr doped LLZO), any garnet system, and lithium nitride (Li₃N). Examples of non-conducting nanoceramics that may be used include lithium fluoride (LiF), lithium phosphate (Li₃PO₄), lithium carbonate (Li₂CO₃), lithium oxide (Li₂O), boron nitride (BN), fluorides (MgF₂, SrF₂), titanium dioxide (TiO₂), aluminum oxide (Al₂O₃), silicon dioxide (SiO₂), or any lithium stable nanoceramic material.

The nanoceramic is dispersed in a polymer base material. Examples of polymer base materials that may be used include polyvinylidene difluoride (PVDF), polyethylene oxide (PEO) or polyoxyethylene (POE) or polyethylene glycol (PEG), polyethylene glycol dimethyl ether (PEGDME), polyacrylonitrile (PAN), poly(methyl methacrylate) (PMMA), poly(oligo(oxyethylene)methacrylate) (POEM), polydimethylsiloxane (PDMS), polyethylene glycol monoacrylate (PEGMA), polyethylene glycol diacrylate (PEGDA), polyethylene glycol dimethacrylate (PEGDMA) poly(vinylidene fluoride-hexafluoropropylene) (PVDF-HFP), liquid crystals, such as liquid crystalline diacrylates (C3M, C6M, etc.), or any polymer that is stable with lithium and dissolvable in a selected process solvent. The nanoceramic is dispersed in the polymer using a suitable dispersant, such as Acumer, Solsperse, Tego dispers, Disperbyk, lithium stearate or any other dispersant stable with lithium and soluble with the selected solvent, or any dispersant capable of dispersing ceramics in a polymeric matrix.

The nanoceramic coating includes a binder material that is formed of an ultraviolet light (UV) curable polymer that enables the coating to be cured by exposing the coating to UV light for a predetermined amount of time, e.g., 3 seconds to 5 minutes. The UV curable polymer may comprise any lithium stable UV-curable polymer. In various examples, the UV curable polymer may comprise a UV curable adhesive material, such as a UV curable super glue, which addresses the issue of poor bonding of the nanoceramic coating on a lithium surface. One or more lithium salts may be added to the UV curable polymer to improve the ionic conductivity of the polymer. Examples of lithium salts that may be added to the UV curable polymer include lithium bis(trifluoromethanesulfonyl)imide (LiTFSI), lithium (flurorosulfonyl) (trifluoromethanesulfonyl)imide (LiFTFSI), lithium bis(fluorosulfonyl) imide (LiFSI), lithium bis(fluorosulfonyl)amide (LiFSA), lithium bis(trifluoromethanesulfonyl)amide (LiTFSA), lithium bis(perfluoroethanesulfonyl)imide (LiBETI), lithium hexafluorophosphate (LiPF₆), lithium tetrafluoroborate (LiFB₄), lithium bis(oxalato)-borate (LiBOB), lithium difluoro(oxalato)borate (LiDFOB), lithium perchlorate (LiClO₄) or any lithium salt that dissociates into cation and anion responsible for ionic conduction. In various examples, the UV curable polymer may include other conductive additives, such as carbon, for improving conductivity of the coating.

In various examples, the materials used to form the nanoceramic coating, i.e., the nanoceramic, polymer, UV curable polymer binder with lithium salts, dispersant, etc., are combined in predetermined ratios/amounts to form the coating. For example, the polymer may be provided for the coating in a range from 1-90 wt. %, the nanoceramic may be provided in a range from 0-80 wt. %., the UV curable polymer may be provided in a range from 0.01-10 wt. %, the lithium salts may be provided in a range from 1-50 wt. %, and the dispersant may be provided in a range from 0.001-5 wt. %. The ratios/amounts of materials used in the coating may be varied to control various properties of the coating, such as ion conduction, electronic conduction, mechanical stability, porosity and the like. In various examples, the nanoceramic coating is applied and cured such that the coating has a thickness in a range of 3-15 microns. In one particular example, the nanoceramic coating has a thickness of 5 microns.

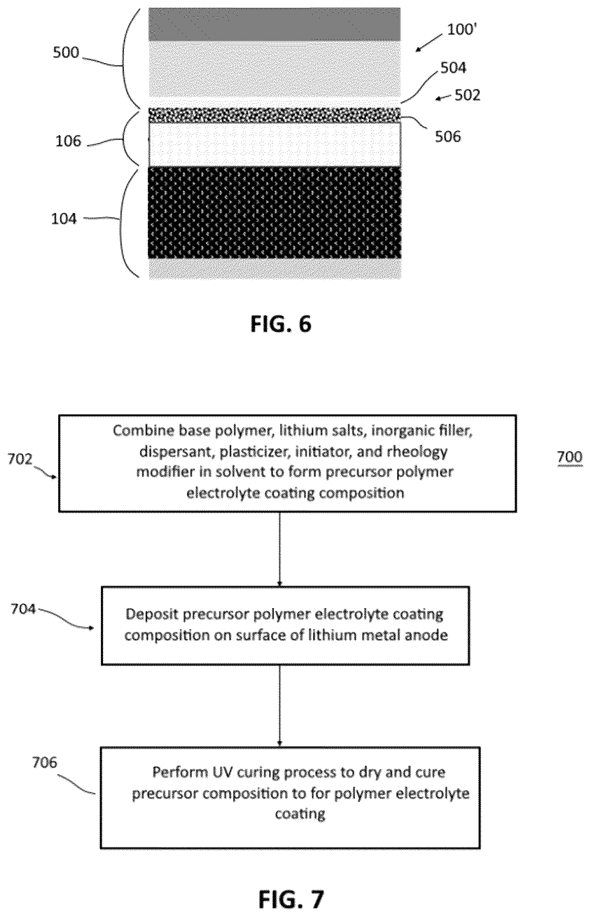

The nanoceramic coating 102 may be applied to the lithium metal anode 304 (e.g., lithium foil) in any suitable manner. An example of a method 400 for providing a nanoceramic protective coating on a lithium metal anode is depicted in FIG. 4. The method 400 begins with dispersing the nanoceramic coating materials. For example, a nanoceramic, base polymer, UV curable polymer binder, lithium salts, and dispersant are combined in a suitable solvent material to form a precursor composition (block 402). In various examples, the precursor composition may comprise a slurry although it is also possible for the composition to be in the form of a solution or suspension. The precursor composition is then coated onto the surface of the lithium metal anode (block 404). In various examples, the precursor composition is spread onto the lithium metal surface using a blade, although any suitable method of applying or depositing the coating onto the surface of the lithium metal anode may be used. The coating is then dried and cured, e.g., using a UV lamp to irradiate the coating for a predetermined amount of time (e.g., 3 seconds to 5 minutes) (block 406).

Once the anode structure 108 (with nanoceramic protective coating) and cathode structure 104 have been formed, the lithium cell 100 as shown in FIG. 1 may be assembled from these parts in any suitable manner. In various examples, the cathode structure 104, electrolyte region 106, and anode structure 108 may be stacked to form the cell. Electrolyte may then be added to the separator. One or more cells may be connected in series and/or parallel and packaged in any suitable manner to form a battery, battery pack, or battery module.

A lithium metal anode with a nanoceramic coating in accordance with this disclosure provides numerous advantages and improvements over previously known lithium anodes and lithium anode protection measures. For example, the nanoceramic coating may be non-porous to prevent the lithium metal anode from coming into contact with electrolyte material, particularly liquid electrolyte material. The nanoceramic coating has an easily controllable thickness. The coating provides good interfacial resistance, is scalable, and inexpensive. The nanoceramic coating is capable of suppressing lithium dendrite formation, improving mechanical and thermal stability, protecting from lithium consumption, and, perhaps most importantly, preventing the lithium metal anode from directly contacting the liquid electrolyte which works to minimize or eliminate consumption of liquid electrolyte, and improving overall safety of the battery.

As noted above, the protective coating 102 for the lithium metal anode 304 may comprise polymer electrolyte coatings. The polymer electrolyte may comprise a composite polymer electrolyte (CPE), solid polymer electrolyte (SPE), gel-polymer electrolyte (GPE), gel composite polymer electrolyte (GCPE), and the like. The polymer electrolyte coating has a material composition that includes a base polymer material (which in this case is used as a binder for the composition), lithium salts for ionic conductivity, and an inorganic filler material. Examples of polymers that may be used for the UV curable polymer electrolyte coating include PEGDA, PEGMA, PEGDMA, PVDF-HFP, PVDF, PEO, PEG, PAN, PMMA, BEMA, combination of above and all possible Li stable polymer materials. Examples of lithium salts that may be used include any lithium stable salt, such as lithium bis(trifluoromethanesulfonyl)imide (LiTFSI), lithium (flurorosulfonyl) (trifluoromethanesulfonyl)imide (LiFTFSI), lithium bis(fluorosulfonyl) imide (LiFSI), lithium bis(fluorosulfonyl)amide (LiFSA), lithium bis(trifluoromethanesulfonyl)amide (LiTFSA), lithium bis(perfluoroethanesulfonyl)imide (LiBETI), lithium hexafluorophosphate (LiPF₆), lithium tetrafluoroborate (LiFB₄), lithium bis(oxalato)-borate (LiBOB), lithium perchlorate (LiClO₄), lithium difluoro(oxalato)borate (LiDFOB), any lithium stable, or any combination of these. In various examples, auxiliary electrolyte may be included to enhance the conductive properties of the coating, such as nonflammable Li stable, non-solvent-based electrolyte. The polymer electrolyte coating may have any suitable concentration of lithium salt. In various examples, the polymer electrolyte coating may comprise a highly concentrated electrolyte (HCE).

The inorganic filler materials are mostly chemically inert but have a high dielectric constant to enhance ion conductivity and high voltage stability. Inorganic filler may include ceramics, nanoceramics, or materials having similar properties. The blending of polymer electrolytes with an inorganic filler may enhance ion mobility and conductivity of the polymer electrolyte while improving the mechanical strength of the polymer. Examples of inorganic fillers that may be used include lithium garnets, such as LLZO, LLZO doped with Al, Ta, Nb and Ga, etc., multivalent doped LLZO garnet, and the like, NASICON powder such as lithium aluminum germanium phosphate (LAGP) and lithium aluminum titanium phosphate (LATP), inactive fillers (such as Al₂O₃, TiO₂, ZnO, SiO₂, and the like), or any possible conventional fillers.

The polymer electrolyte protective coating also may include a dispersant, a plasticizer, a polymerization initiator (e.g., thermal and/or photo), and a rheology modifier. The dispersant is used to disperse particles, such as the inorganic filler, in the base polymer material. Any suitable dispersant may be used. Plasticizers may be added to polymer electrolytes to enhance the ionic conductivity and the film-forming capability of the coating. In particular, the addition of plasticizer lowers the glass transition temperature of the polymer and effectively enhances salt dissociation into the polymer matrix which increases the ability of the polymer electrolyte to transport ions. Any suitable plasticizer or fire-retardant plasticizer may be used, such as triethylene glycol dimethyl ether (triglyme, TEGDME), succinonitrile (SCN), triphenyl phosphate (TPP), or any Li compatible plasticizer.

The polymerization initiator is a compound that generates radicals or cations upon exposure to heat and/or light. The polymerization initiator is used to initiate polymerization (i.e., curing) of the composition in response to being irradiated by UV light or being subjected to heat. Any suitable thermal and/or photo initiator may be used. A rheology modifier is included in the composition. Rheology modifiers are additives to polymer compositions that may be used to alter the rheologic properties (e.g., deformation and flow characteristics) of a composition. In various examples, the rheology modifier comprises an acrylic polymer diluted by a reactive diluent which is used as the primary or a modifying oligomer in UV or electron beam (EB) curable formulations to improve film properties such as adhesion and lay-down. In this case, the rheology modifier may be used to promote adhesion and lay-down of the coating on the surface of the lithium metal anode.

In various examples, the materials used to form the polymer electrolyte coating, i.e., such as the base polymer, lithium salts, inorganic filler, dispersant, plasticizer, polymerization initiator, auxiliary electrolyte (non-flammable ionic conduction enhancer), and rheology modifier, are combined in predetermined ratios/amounts to the coating. For example, the base polymer may be provided for the coating in a range from 20-40 wt. %, the lithium salts may be provided in a range from 10-25 wt. %, auxiliary electrolyte may be provided in a range from 10-70 wt. %, the initiator may be provided in a range from 0.05-2 wt. %, the plasticizer may be provided in range from 2-30 wt. %, the inorganic filler may be provided in a range from 10-95 wt. %, the dispersant may be provided in a range from 0.5-2 wt. %, and the rheology modifier may be provided in a range from 1-15 wt. %. The ratios/amounts of materials used in the coating may be varied to control various properties of the coating, such as ion conduction, electronic conduction, mechanical stability, porosity and the like. In various examples, the polymer electrolyte coating is applied and cured such that the coating has a thickness in a range of 1-40 microns. The polymer electrolyte coating may be dried and cured in any suitable manner, such as by drying using natural or forced convection heating or IR radiation, and by curing using an ultraviolet light (UV) curing process, or various combinations of these.

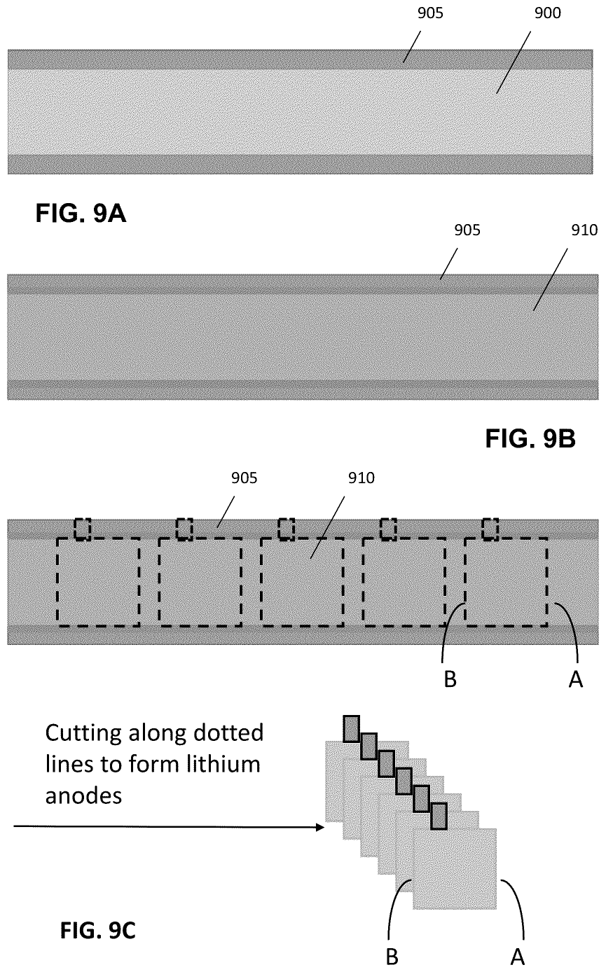

Similar to the nanoceramic coating, the polymer electrolyte coating may be applied to the lithium metal anode (e.g., lithium foil) in any suitable manner. An example of a method 700 for providing a polymer electrolyte protective coating on a lithium metal anode is shown in FIG. 7. The method begins with combining the polymer electrolyte coating materials, such as the base polymer, lithium salts, inorganic filler, dispersant, plasticizer, polymerization initiator, and rheology modifier, auxiliary non-flammable electrolyte in a suitable solvent material to form a precursor composition (block 702). In various examples, the precursor composition may comprise a slurry although it is also possible for the composition to be in the form of a solution or suspension. The precursor composition is then coated onto the surface of the lithium metal anode (block 704). In various examples, the precursor composition is spread onto the lithium metal surface using a blade although any suitable method of applying or depositing the coating onto the surface of the lithium metal anode may be used. The polymer electrolyte coating may then be dried and cured in any suitable manner, such as by drying using natural or forced convection heating or IR radiation, and by curing using an ultraviolet light (UV) curing process, or various combinations of these (block 706).

Similar to the nanoceramic protective coating, the polymer electrolyte protective coating on a lithium metal anode provides numerous advantages and improvements over previously known lithium anodes and lithium anode protection measures. For example, the coating should be non-porous to prevent the lithium metal anode from contact with electrolytes, has controllable thickness, provides good interfacial resistance, and is scalable and inexpensive. The polymer electrolyte coating is capable of suppressing lithium dendrite formation, improving battery safety (e.g. passing nail penetration test), improving ionic conductivity, improving mechanical and thermal stability, protecting from lithium consumption, and, perhaps most importantly, preventing the lithium metal anode from directly contacting the liquid electrolyte which works to minimize or eliminate consumption of liquid electrolyte.

In various examples, other protective coatings may be provided as an alternative or in addition to the above-described coatings. In one particular example, protective coatings in the form of ceramic coatings may be provided. In various other examples, ceramic materials such as lithium phosphorus oxynitride (LiPON), aluminum oxide (Al₂O₃), titanium dioxide (TiO₂), zinc oxide (ZnO), and the like, which may be coated onto the lithium metal anode or onto other coatings using a suitable technique, such as atomic layer deposition (ALD), sputtering, and evaporation. In some examples, a protective coating may comprise a lithium alloy material, such as lithium-tin (Li—Sn), lithium-indium (Li—In), lithium-silver (Li—Ag), lithium-gallium (Li—Ga), and any binary or tertiary combination of those, etc. In various examples, the lithium alloy coating may be used to replace the lithium anode or layered on top of a lithium metal anode or a lithium alloy anode to provide additional protection for the anode.

As discussed above, protective coatings may be provided as a single layer, such as depicted in FIG. 3, of one of the types of protective coatings described above. In various examples, protective coatings may be provided with multiple layers having the same or different types of coatings. For example, the protective coating may comprise multiple layers of combinations of ceramic and nanoceramic protective coatings, combinations of ceramic and polymer electrolyte protective coatings, combinations of lithium alloy and nanoceramic protective coatings, and lithium alloy and polymer electrolyte protective coatings.

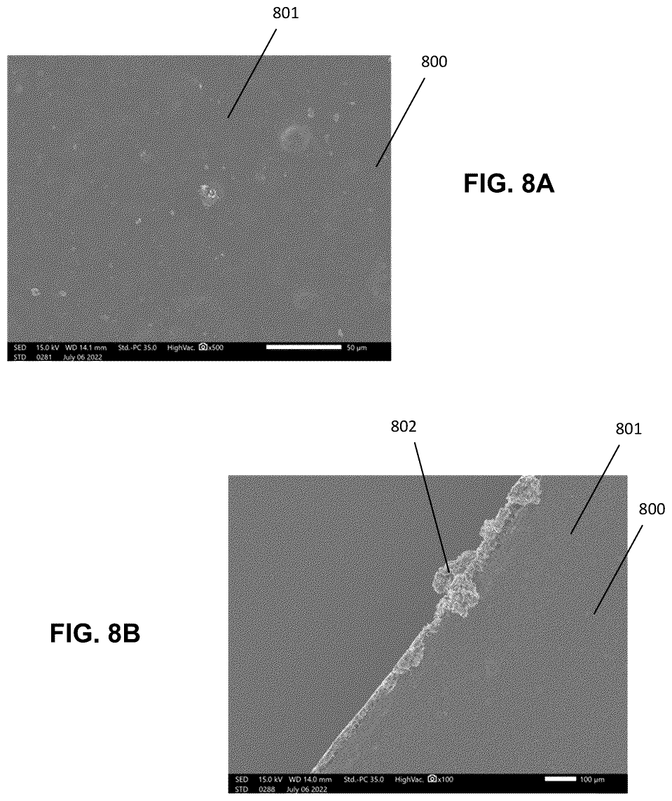

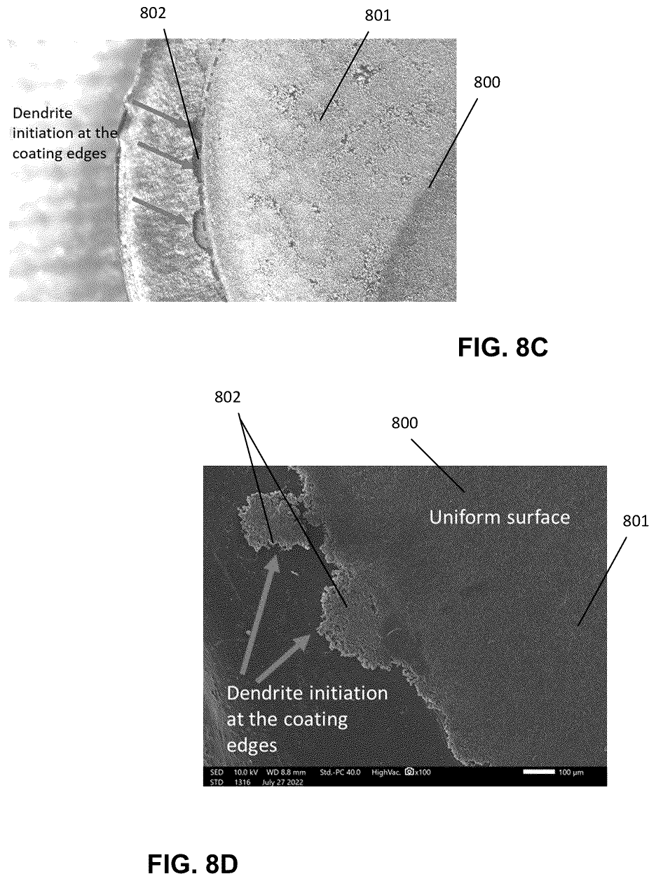

An example of a lithium cell 100 having an anode structure 500 with a multi-layer nanoceramic coating 502 is shown in FIG. 5A. In this example, the multi-layer nanoceramic coating 502 includes a first ceramic layer 504 and a second layer 506 which corresponds to the nanoceramic layer. The first ceramic layer 504 is deposited directly onto the surface of the lithium metal anode 508. The nanoceramic coating 506 is then applied on top of the first ceramic layer. The first ceramic layer 504 may be formed of a thin layer of pure (e.g., 100%) ceramic, such as lithium phosphorus oxynitride (LiPON), aluminum oxide (Al₂O₃), titanium dioxide (TiO₂), zinc oxide (ZnO), lithium phosphate (Li₃PO₄), etc., with or without microcracks using a high-volume scalable solution method or dense almost pore free LiₓPOyN_{z} (x≈3, z<0.5, and 3<(y+z)<4), LiF, MgF₂, SrF₂ sputtered on lithium using low volume scalable dry method or, in some cases, by metal organic chemical vapor deposition (MOCVD), e.g., MgF₂, before coating with the nanoceramic composite. The nanoceramic layer 506 may then be applied onto the first ceramic layer 504 as described above. The additional coating layer 504 provides double protection of lithium metal further ensuring non-contact with liquid electrolyte, non-consumption of lithium, dendrite suppression, improved safety during thermal runaway by shielding lithium from exposure to fresh oxygen gas release from the cathode active material. FIG. 6 shows the cell assembly 100′ for the anode structure 500 having the two-layer protective coating 502 of FIG. 5 including the electrolyte region 106 and cathode structure 104, as described above.

FIGS. 5B-5E show additional non-limiting examples of protective coatings with multiple layers of different types of coatings. FIG. 5B shows an example of an anode structure 510 including an anode current collector 512 and lithium anode 514 and a protective coating having a pure ceramic coating 516 and a nanoceramic coating 518. FIG. 5C shows an example of an anode structure 520 that includes an anode current collector 522 and a lithium anode 524 and a protective coating having a pure ceramic coating 526 and a polymer electrolyte coating 528.

The examples of FIGS. 5D and 5E show combinations of protective coatings including lithium alloy. For example, FIG. 5D shows an example of an anode structure 530 including an anode current collector 532 and lithium anode 534 and a protective coating comprising a lithium alloy layers 536 and a nanoceramic layer 538 formed on the lithium alloy layer 536. Alternatively, the lithium alloy layer 536 can be formed directly on the anode current collector and serve as the anode for the anode structure. FIG. 5E shows an example of an anode structure 540 including an anode collector 542 and lithium anode 544 and a protective coating comprising a lithium alloy layer 546 and a polymer electrolyte layer 548 formed on the lithium alloy layer 546. Alternatively, the lithium alloy layer 546 can be formed directly on the anode current collector and serve as the anode for the anode structure.

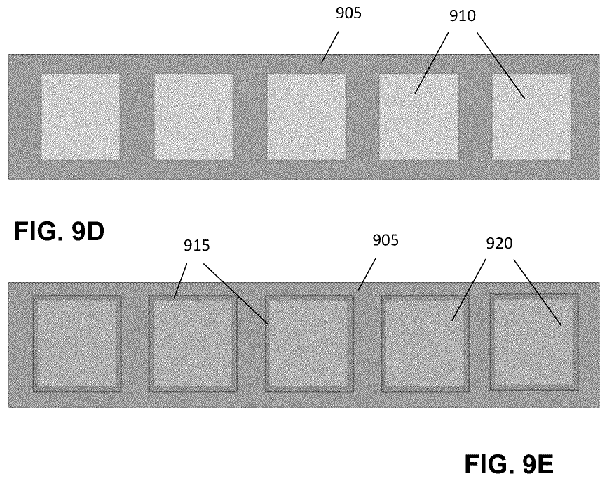

Turning FIG. 8A, this figure is an image from a scanning electron microscope (SEM) of an anode electrode 800 that is made of a lithium foil covered with a gel-polymer electrolyte (GPE) as a protective coating 801. As described above, the protective GPE coating 801 is to prevent the underlying lithium foil from having contact with the liquid electrolyte that is disposed between the anode and cathode electrodes of a lithium-ion battery.

FIG. 8A illustrates a central area of the anode electrode 800 after the battery containing the electrode has experienced a single charging cycle in an open cell configuration. The central area is completely covered by the GPE coating 801. Consequently, there is no evidence in the image of any degradation of the anode, specifically the formation of any dendrites.

As was described above, the use of lithium metal as an anode electrode material in rechargeable batteries poses several concerns, particularly the following. When a lithium-metal battery discharges, electrons move through an external load from the anode. Simultaneously, lithium ions separate from the surface or de-plate from the anode and travel to the cathode. When the battery is charged, the lithium ions travel back and deposit/plate onto the anode as lithium metal. However, instead of forming a nice smooth plated layer on the anode, the lithium metal has the tendency to generate “dendrites” or chains of lithium atoms that look like tree roots growing from the surface of the anode. These dendrites grow bigger with each charge-discharge cycle and can eventually reach the cathode and short the battery. This leads to battery failure and potentially a thermal runway event causing fire.

To prevent this dendrite formation, as described above, a protective coating, such as the GPE coating 801 of FIG. 8A, is formed over the lithium anode electrode 800. As seen in FIG. 8A, this coating 801 is shown effective for this purpose and is able to greatly enhance the useful life and safety of the lithium-ion battery. As described above, many types of coatings, as alternatives to a GPE coating, can achieve this advantage.

In FIG. 8B, the SEM observes the same anode electrode 800 in a different location. In FIG. 8B, we see an edge portion of the GPE coating 801. Beyond the edge of the GPE coating 801, there is lithium metal of the anode electrode 800 that is not protectively covered and is exposed to the liquid electrolyte. Accordingly, along this edge, the SEM image of FIG. 8B observes the formation of dendrites 802 of lithium that have begun to form. Such uncoated edges of the anode electrode 800 can result, for example, from the punching or cutting steps that are used in produce the electrode structure.

FIG. 8C is an optical image of a lithium anode 800 with a GPE coating 801 after a larger number of charge/discharge cycles in a coin-cell configuration. Again, dendrites 802 are observed to form at the edge region of the coating. FIG. 8D is an SEM image of a lithium anode 800 with GPE coating 801 after a larger number of charge/discharge cycles in a coin-cell configuration. Again, dendrites 802 are observed to form at the edge region of the coating.

Having these dendrites only at the edge of the anode, as seen in FIGS. 8B-8D, will still significantly improve the useful life and safety of the battery as compared to using an unprotected lithium anode electrode with no protective coating. However, as disclosed herein, a protective coating 801 of any of the materials described can be intentionally extended to cover the edge portions and all exposed areas of the lithium metal anode. This will further enhance the useful life and safety of the resulting lithium-ion battery.

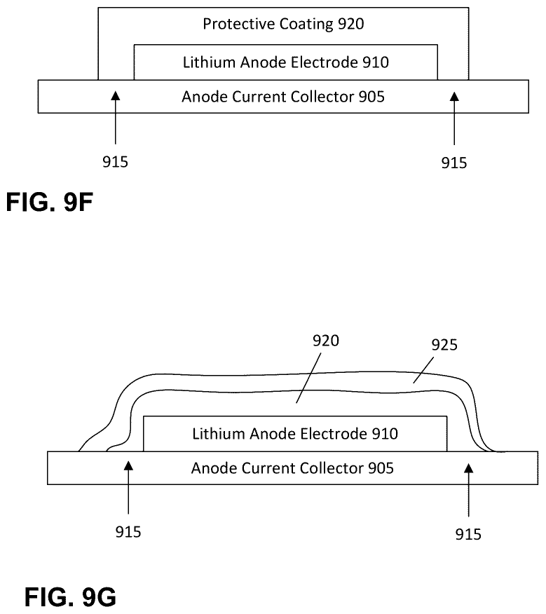

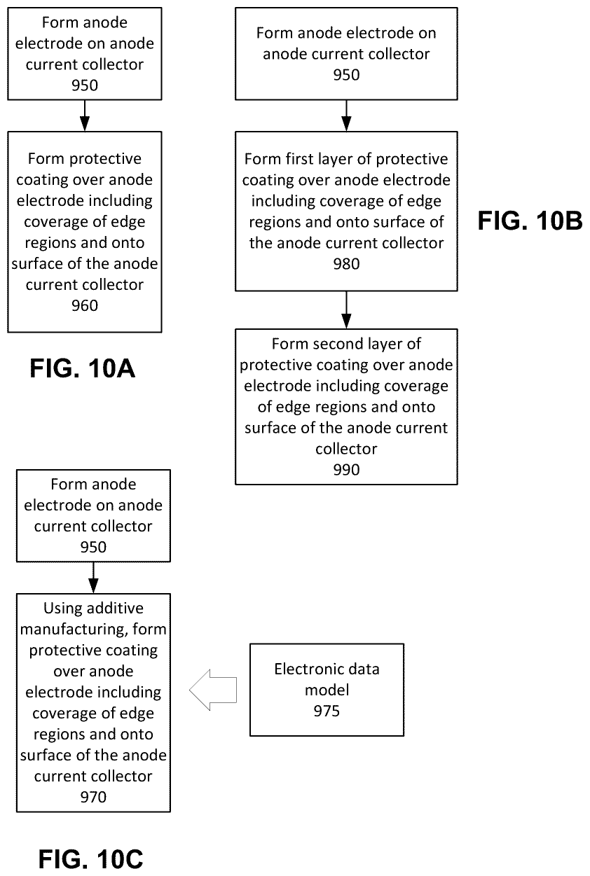

FIGS. 9A and 9B illustrate a typical process of providing a protective coating on a lithium surface to form lithium anode electrodes for use in a lithium-ion battery. FIG. 9A is a plan view of a lithium foil sheet or strip comprising lithium metal layer 900 that has been formed on an anode current collector 905. As noted above, the anode current collector 905 may be used as a substrate and mechanical support for the lithium metal 900. In this example, the anode current collector 905 is composed of copper (Cu), but could be composed of other conductive materials. In FIG. 9B, the lithium metal layer 900 has been covered with a protective coating 910. This protective coating 910 may be composed and formed according to any of the examples provided above. In FIG. 9C, the lithium foil strip coated with the protective coating 910 is cut along the dotted lines to form individual anode electrodes, which are used for assembly of battery cells, e.g. pouch cells.

One problem encountered in the above process is that the cutting step creates exposed uncoated edges of the lithium metal electrodes, e.g. at least edges A and B as shown in FIG. 9C. The uncoated edges of the lithium metal electrodes can cause dendrite growth and shorting issues. To solve this problem, FIGS. 9D and 9E depict an improved process of providing a protective coating on not only the top surface but also all edges of the lithium metal anodes. In FIG. 9D, lithium metal layer is formed into predetermined electrode patterns or segments 910 of lithium metal anodes on an anode current collector 905. In FIG. 9E, the lithium anode electrode segments 910 have been covered with a protective coating 920. Specifically, the protective coating 920 covers and extends beyond the area of each of the anode electrode segments 900 and onto the surface of the underlying anode current collector 905. The protective coating thus seals edges of the lithium metal anode segments between adjacent segments. After the protective coating, the unit shown in FIG. 9E can be cut between the electrode segments to to form individual anode electrodes. Then, each anode electrode can be used in a battery assembly and each will have full coverage of all edges by the protective coating 920.

In various examples, the lithium the lithium anode electrode segments 910 may comprise a lithium alloy material, such as lithium-tin (Li—Sn), lithium-indium (Li—In), Lithium-Galium, lithium-silver (Li—Ag) and combinations of them. In these examples, the lithium alloy anode also serves as a protective coating which is more resistant to side reactions, such as dendrite formation and/or unstable SEI formation, than other lithium metal anodes. As described below, lithium alloy coatings may also be used as a protective coating that can be layered with other protective coating(s) to provide additional protection for the lithium anode.

The anode electrode segments 910 may be formed on the anode current collector 905 in any suitable manner. However, using lithium foil to form the anode electrode segments 910 can create issues with the subsequent technique of providing protective coating over the edge regions. Rather, Li deposition using a slurry or evaporation technique provide Li metal in a patterned deposition so that the subsequent protective coating can cover the otherwise unprotected edge regions of the anode electrode segments 910. Thus, in various examples, evaporation and sputtering techniques may be used. Lithium may also be screen printed onto the anode current collector 905 using stabilized lithium powder as a slurry. In various examples, a calendaring process may be utilized to compress the anode electrode segments 910 to achieve a desired level of porosity and/or thickness for the anode electrode 910 after the screen printing and drying. In various examples, the lithium anode electrode 910 may have a thickness in a range from 0.1 to 200 microns.

In FIG. 9E, the lithium anode electrode segments 910 have been covered with a protective coating 920. This protective coating 920 may be composed and formed according to any of the examples provided above. Specifically, the protective coating 920 can be applied in a patterned format, for example by additive manufacturing or printing, over the anode electrode segments 910. Additive manufacturing, also known as 3D printing, is a process in which a three-dimensional object, in this case the layer of protective coating, is built from a computer-aided design (CAD) model or electronic data model, usually by successively adding materials in a layer-by-layer fashion. A printhead, such as a thermal or piezoelectric printhead, can be used to eject the material of the protective coating at precise locations where the coating is intended to be, including coverage of the edge regions of the anode electrode 910. Various techniques for additive manufacturing could be adapted for use in forming the protective coating. However, the selective deposition techniques of additive manufacturing may be most applicable to forming the protective coating 920.

As to composition, for example, protective coatings for coating the lithium metal of the anode electrode 900 include nanoceramic coatings and polymer electrolyte coatings, including polymeric, ionically conductive composite materials including inorganic particles and various other materials in different formulations for imparting desired characteristics to the coatings and that enable the coatings to be adhered/affixed to a surface of the lithium metal anode, such as by using an ultraviolet light (UV) curing process. In other examples, non-polymeric protective coatings may be used, such as pure ceramic coatings and lithium alloy coatings. The protective coatings described herein, such as nanoceramic protective coatings, polymer electrolyte protective coatings, ceramic protective coatings and lithium alloy coatings, may be provided as a single layer or multiple layers and may be used alone or in combination with each other and/or other types of protective coatings. The coatings may be non-porous in order to prevent the lithium anode surface from directly contacting liquid electrolyte and to limit undesired side reactions, such as dendrite formation and/or unstable SEI formation that can lead to unwanted consumption of the liquid electrolyte and Li metal itself. The protective coatings may also improve mechanical and thermal stability and improve ionic conductivity while also protecting from lithium consumption and promoting the overall safety of the battery.

As further shown in FIG. 9E, the coating 920 extends over a region 915 that covers an edge of the anode electrode 910 and extends onto a portion of the anode current collector 905. In this way, the edge of the anode electrode 910 is entirely covered by the protective coating 920. Thus, there may be no portion of the anode electrode 910 that is exposed to contact with a liquid electrolyte.

FIGS. 9F and 9G are additional illustrations from a cross-sectional view of the anode structure of either of FIGE. As shown in FIG. 9F, the lithium anode electrode 910 is formed on the anode current collector 905, as described above. The protective coating 920, as described above, is formed over the lithium anode electrode 910. As shown, the protective coating 920 extends beyond the edges of the lithium anode electrode to cover the edges of the lithium anode electrode 910 as well as a small surrounding portion of a surface of the anode current collector 905.

FIG. 9F further demonstrates that the protective coating can be formed of multiple coating layers, including an inner layer 920 and an outer layer 925. Any of the examples of pairs of different coating materials shown in FIGS. 5B-5E or others can be utilized in examples of an anode structure according to FIG. 9F. This includes: a nanoceramic layer over a ceramic layer (FIG. 5B), a polymer electrolyte layer over a ceramic layer (FIG. 5C), a nanoceramic layer over a lithium alloy layer (FIG. 5D) or a polymer electrolyte layer over a lithium alloy layer (FIG. 5E). Other possible combinations of protective coating materials are described herein.

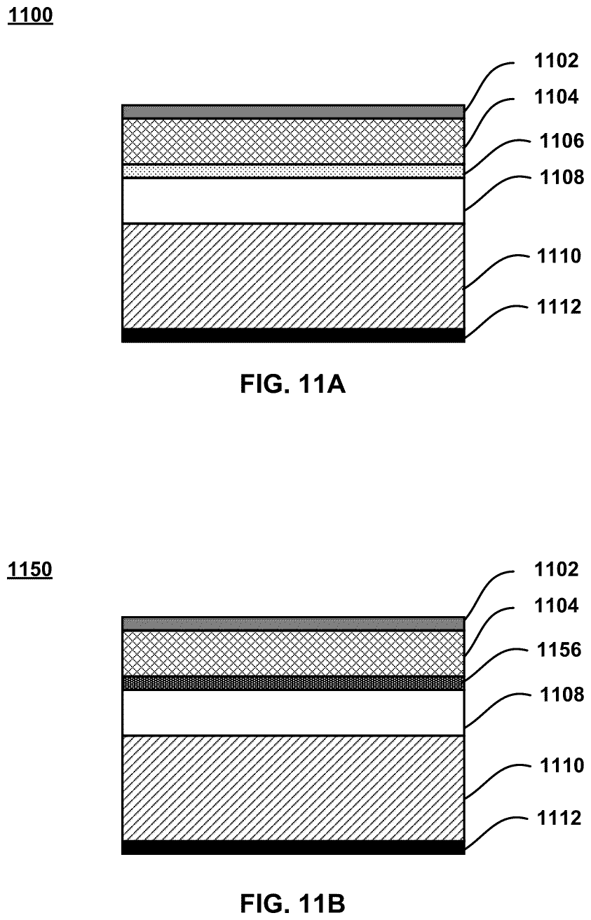

FIGS. 10A-10C are flowcharts depicting methods used for forming the fully-protected anode electrode described herein. As shown in FIG. 10A, the method described herein includes forming an anode electrode on an anode current collector 950. This will likely leave a stepped or sloping edge region of the anode electrode where the anode electrode does not extend over the full surface of the anode current collector. Accordingly, the method includes forming a protective coating 960, as described herein, over the anode electrode, specifically including coverage of edge regions of the anode electrode, the protective coating 960, in some examples, extending beyond the anode electrode and onto a surface of the anode current collector.

FIG. 10B illustrates the same subject matter, but further details that the protective coating may be formed as follows. A first layer 980 of the protective coating is formed, specifically including coverage of edge regions of the anode electrode. Then, a second layer 990 of the protective coating, using a different coating material is formed, specifically including coverage of edge regions of the anode electrode. In both cases, the two layers of the protective coating may extend beyond the anode electrode and onto a surface of the anode current collector.

FIG. 10C illustrates the same subject matter, but specifies that additive manufacturing 970 is used to form the protective coating. For example, an electronic data model 975 of the protective coating is input to the additive manufacturing system to guide the selective deposition of material to form the protective coating. This is true whether the coating is formed in one or multiple layers as in FIGS. 10A and 10B, respectively.

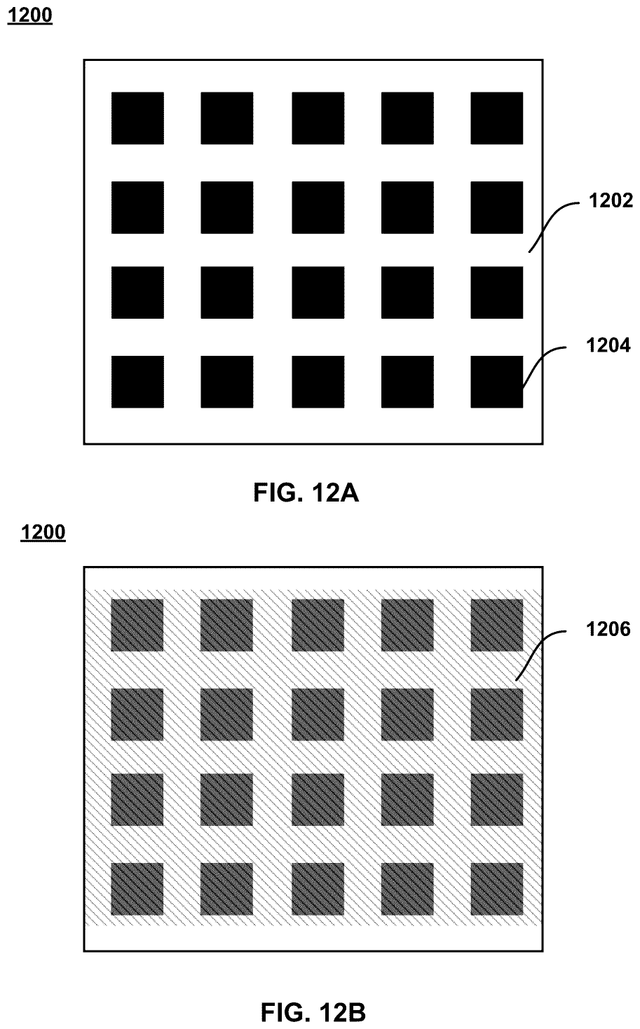

FIGS. 11A and 11B illustrate example lithium metal cells 1100 and 1150 for a battery that includes protective coatings 1106 and 1156 respectively, in accordance with this disclosure. The lithium cells 1100 and 1150 of FIGS. 11A and 11B additionally include negative current collector 1102, lithium metal anode 1104, composite polymer electrolyte (CPE) 1108, composite cathode 1110, and positive current collector 1112.

FIG. 11A shows lithium metal cell 1100 where a layer of porous lithium nitride (LiN) is infused with CPE on lithium metal anode 1104. In this example, protective coating 1106 is made by forming a porous lithium nitride structure 1106 on the surface of lithium metal anode 1104. For example, the porous lithium nitride structure 1106 can be formed on lithium metal anode 1104 in a heated chamber by the reaction of the lithium metal with nitrogen gas. The porous lithium nitride structure is then coated and infused with CPE. This infused CPE may also include high conducting carbon particles, fibers, or metallic powder. Using lithium metal anode 1104 as the substrate, CPE 1108 layer is spread uniformly either by casting or printing to complete the formation of the anode as well as separator of lithium metal cell 1100. To complete the lithium metal cell 1100, composite cathode 1110 and positive current collector 1112 are attached thereto to complete cell formation. In various examples, composite cathode 1110 includes a high voltage cathode active material, composite polymer electrolyte as the binder and a high conducting carbon on positive current collector 1112.

Similarly, FIG. 11B shows lithium metal cell 1150 that, instead of porous LiN infused with CPE on lithium metal anode 1104, protective coating 1156 is made by forming a porous lithium fluoride structure or layer on lithium metal anode 1104 and then infused with CPE. The porous lithium fluoride structure may be formed in a vacuum chamber by reaction with a gas mixture including argon and a fluorine containing compound such as trifluoromethane (CHF3), carbon tetrafluoride (CF4), and nitrogen trifluoride (NF3), etc. Accordingly, CPE 1108 layer is then spread on top of the lithium fluoride layer to complete the formation of anode.

Accordingly, incorporation of protective coatings 1106 and 1156 on lithium metal anode would help improve battery cell cycle performance. Having protective layers composed of a porous lithium nitride structure infused with the composite polymer electrolyte, as shown in FIG. 11A, or one formed from porous LiF layer on lithium metal anode 1104, as shown in FIG. 11B, improves the mechanical binding of CPE 1108 to lithium metal anode 1104, which improves interface stability, thus, helps extend battery cycle life.

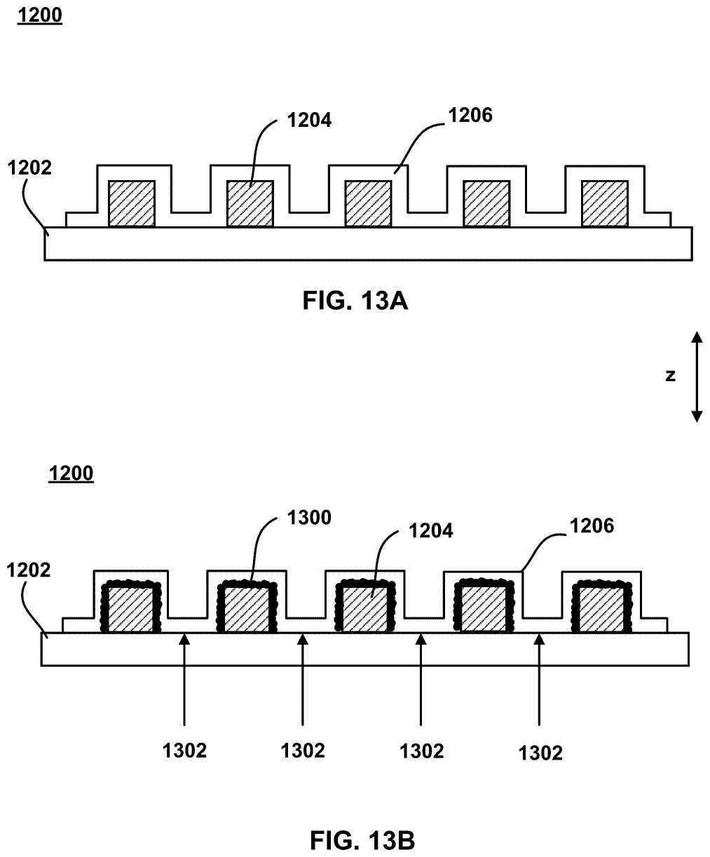

In another example, the adhesion of the protective coating to the lithium metal anode can be enhanced by employing a patterned lithium anode, as illustrated in FIGS. 12A-13B. FIG. 12A shows patterned electrode 1200 including substrate 1202, such as a copper current collector, and lithium segments 1204 arranged in an array pattern, in accordance with this disclosure. As further shown in FIG. 12B, the array pattern is covered with protective coating 1206 extending over substrate 1202 and lithium segments 1204. The size (e.g., x and y dimensions) of the lithium segments 1204 can be in a range of 20 um to 20 mm and the space between the segments can be in a range of 10 to 200 um.

Patterned electrode 1200 can be formed in several ways. For example, patterned electrode 1200 can be formed using photolithography to first pattern the surface of substrate 1202 with polymer/photoresist. Then, lithium segments 1204 can be deposited using evaporation, sputtering, PVD or electrodeposition and, thereafter, the polymer/photoresist is removed to reveal the lithium pattern. In another example, photolithography can be used to first pattern substrate 1202 with modified silicon, then lithium segments 1204 can be deposited on the surface using evaporation, sputtering PVD or electrodeposition. In another example, a physical mask can be used to cover the surface of substrate 1202, then lithium segments 1204 can be deposited on the surface using evaporation, sputtering PVD or electrodeposition. In another example, then lithium segments 1204 can be formed by screen printing using a slurry or an ink containing stabilized lithium powder. In various examples, the lithium segments 1204 may have a thickness in a range from 0.1 to 200 microns.

FIG. 13A-13B show a side view of patterned electrode 1200, in accordance with this disclosure. In lithium metal battery cells, volume expansion is common during operation due to the continuous growth of the solid electrolyte interface (SEI) layer or buildup of byproducts between the protective coating layer and the lithium metal surface. For a multi-layer battery cell with continuous lithium metal anodes as opposed to the patterned lithium anode, the only possible direction of volume expansion is in the stacking direction (i.e., z-direction). This volume expansion of the lithium anode can cause detachment or delamination of the protective coating from the lithium metal anode. FIG. 13A shows a side view of pattered electrode 1200 that has not undergone any volume expansion and FIG. 13B shows a side view of patterned electrode 1200 that has undergoing volume expansion through SEI 1300 growth, in accordance with this disclosure. In this example, however, substrate 1202 surrounding each lithium segment 1204 does not undergo volume expansion, thus providing adhesion directly to the protective coating 1206 in regions 1302 between lithium segments 1204 where there is no lithium, thus, maintaining mechanical integrity of the lithium anode covered by protective coating 1206. Further shown, in FIG. 13B, regions 1302 between lithium segments 1204 allow lithium dendrite to grow laterally or horizontally (in the x-y plane of the anode instead of only in the z-direction), thus, prolonging the time it may take to encounter a dendrite shorting issue and increasing battery life.

In the following, further features, characteristics, and advantages of the instant application will be described via the following items:

Item 1. A lithium cell for a lithium metal battery comprising:
an electrolyte material;
a cathode structure arranged on one side of the electrolyte material, the cathode structure including a cathode electrode and a cathode current collector; and
an anode structure arranged on an opposite side of the electrolyte material from the cathode structure, the anode structure including:
   an anode current collector;
   a lithium metal anode arranged on a side of the anode current collector arranged facing the electrolyte material; and
   a protective coating deposited on a surface of the lithium metal anode and arranged facing the electrolyte material, wherein the protective coating extends beyond the lithium metal anode and onto the anode current collector to seal both a surface and edge regions of the lithium metal anode from contact with a liquid electrolyte of the electrolyte material.

Item 2. The lithium cell of Item 1, wherein the lithium metal anode is formed into separate segments along the anode current collector, the protective coating sealing edges of the lithium metal anode segments between adjacent segments of the lithium metal anode.

Item 3. The lithium cell of Item 1, wherein the lithium metal anode is formed from a patterned deposition of material rather than from a foil.

Item 4. The lithium cell of Item 1, wherein the protective coating comprises an inner layer and an outer layer, each layer being of a different coating material.

Item 5. The lithium cell of Item 1, wherein the protective coating is formed by additive manufacturing.

Item 6. The lithium cell of Item 1, wherein the protective coating comprises at least one polymer electrolyte layer including:
a base polymer material;
one or more lithium salts;
inorganic filler;
dispersant;
plasticizer;
auxiliary electrolyte;
an initiator; and
a rheology modifier.

Item 7. The lithium cell of Item 1, wherein the protective coating includes at least one lithium alloy layer, the at least one lithium alloy layer serving as the lithium metal anode, and wherein the polymer electrolyte layer is deposited on the at least one lithium alloy layer.

Item 8. The lithium cell of Item 1, wherein the protective coating includes at least one ceramic layer, the at least one ceramic layer being deposited on the lithium metal anode, and wherein the polymer electrolyte layer is deposited on the at least one ceramic layer.

Item 9. The lithium cell of Item 1, wherein the protective coating comprises porous lithium nitride infused with composite polymer electrolyte.

Item 10. The lithium cell of Item 9, wherein the infused composite polymer electrolyte comprises at least one of conductive carbon particles, conductive carbon fibers, or metallic powder.

Item 11. The lithium cell of Item 1, wherein the protective coating comprises porous lithium fluoride infused with composite polymer electrolyte.

Item 12. The lithium cell of Item 1, wherein the lithium metal anode comprises separate lithium segments arranged in an array pattern on the anode current collector, wherein the protective coating adheres directly to the anode current collector between the separate lithium segments and extends over and beyond the pattern of the separate lithium segments to seal the surface and the edge regions of the separate lithium segments from contact with the liquid electrolyte of the electrolyte material.

Item 13. The lithium cell of Item 12, wherein x and y dimensions of the lithium segments can be in a range of 20 μm to 20 mm and space between the segments can be in a range of 10 to 200 μm.

Item 14. A method of providing a protective coating on a lithium metal anode, the method comprising:
forming a lithium anode electrode on an anode current collector, the anode current collector being a substrate providing support for the lithium anode electrode; and
forming a protective coating over the lithium anode electrode, the protective coating extending beyond edges of the lithium anode electrode and onto surrounding portions of the anode current collector;
wherein both edge and surface regions of the lithium anode electrode are covered by the protective coating to prevent contact with a liquid electrolyte.

Item 15. The method of Item 14, wherein forming the protective coating comprises additive manufacturing to deposit material of the protective coating over the lithium anode electrode.

Item 16. The method of Item 14, wherein forming the protective coating comprises:
forming an inner layer of protective coating on the lithium anode electrode; and
forming an outer layer of protective coating over the inner layer on the lithium anode electrode, the inner and outer layers of protective coating being of different materials.

Item 17. The method of Item 16, further comprising using additive manufacturing to form both the inner and outer layers of protective coating.

Item 18. The method of Item 14, wherein forming the lithium anode electrode does not involve using a lithium foil, but includes a patterned deposition of anode material.

Item 19. The method of Item 14, wherein forming the lithium anode electrode comprises using a slurry or evaporation technique.

Item 20. The method of Item 14, wherein forming the protective coating comprise:
combining a base polymer material, one or more lithium salts, inorganic filler, dispersant, plasticizer, a polymerization initiator, auxiliary non-flammable electrolyte and a rheology modifier in a solvent to form a precursor polymer electrolyte composition;
depositing the precursor polymer electrolyte composition on a surface of the lithium metal anode; and
irradiating the precursor polymer electrolyte composition with an ultraviolet (UV) light for a predetermined length of time to dry and cure the precursor polymer electrolyte composition to form a polymer electrolyte protective coating on the surface of the lithium metal anode.

Item 21. The method of Item 20, wherein depositing the precursor polymer electrolyte composition comprises using an additive manufacturing printhead to deposit the precursor polymer electrolyte composition on the surface of the lithium metal anode.

Item 22. The method of Item 14, wherein forming the protective coating comprises:
forming a porous lithium nitride structure or porous lithium fluoride structure on the lithium anode electrode; and
infusing the porous lithium nitride or lithium fluoride structure with composite polymer electrolyte.

Item 23. The method of Item 14, wherein forming a protective coating over the lithium anode electrode comprises:
forming the lithium metal anode comprising separate lithium segments arranged in an array pattern on the anode current collector, wherein the protective coating adheres directly to the anode current collector between the separate lithium segments and extends over and beyond the pattern of the separate lithium segments to seal the surface and the edge regions of the separate lithium segments from contact with the liquid electrolyte of the electrolyte material.

Item 24. The method of Item 23, wherein x and y dimensions of the lithium segments can be in a range of 20 μm to 20 mm and space between the segments can be in a range of 10 to 200 μm.

Item 25. A method of providing a protective coating on a lithium metal anode, the method comprising:
forming a lithium anode electrode on an anode current collector, the anode current collector being a substrate providing support for the lithium anode electrode; and
using a selective deposition additive manufacturing system, depositing a protective coating over the lithium anode electrode according to an electronic data model of the coating, the protective coating extending beyond edges of the lithium anode electrode and onto surrounding portions of the anode current collector;
wherein both edge and surface regions of the lithium anode electrode are covered by the protective coating to prevent contact with a liquid electrolyte.

Item 26. The method of Item 25, wherein forming the protective coating comprises:
forming an inner layer of protective coating on the lithium anode electrode; and
forming an outer layer of protective coating over the inner layer on the lithium anode electrode, the inner and outer layers of protective coating being of different materials.

Item 27. The method of Item 25, wherein forming the lithium anode electrode does not involve using a lithium foil, but includes a patterned deposition of anode material including using a slurry or evaporation technique.

Item 28. The method of Item 25, further comprising:
combining a base polymer material, one or more lithium salts, inorganic filler, dispersant, plasticizer, a polymerization initiator, auxiliary non-flammable electrolyte and a rheology modifier in a solvent to form a precursor polymer electrolyte composition;
depositing the precursor polymer electrolyte composition on a surface of the lithium metal anode as the protective coating; and
irradiating the precursor polymer electrolyte composition with an ultraviolet (UV) light for a predetermined length of time to dry and cure the precursor polymer electrolyte composition to form a polymer electrolyte protective coating on the surface of the lithium metal anode.

While various examples have been described, the description is intended to be exemplary, rather than limiting, and it is understood that many more examples and implementations are possible that are within the scope of the examples. Although many possible combinations of features are shown in the accompanying figures and discussed in this detailed description, many other combinations of the disclosed features are possible. Any feature of any example may be used in combination with or substituted for any other feature or element in any other example unless specifically restricted. Therefore, it will be understood that any of the features shown and/or discussed in the present disclosure may be implemented together in any suitable combination.

Unless otherwise stated, all measurements, values, ratings, positions, magnitudes, sizes, and other specifications that are set forth in this specification are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A lithium cell for a lithium metal battery comprising:
an electrolyte material;
a cathode structure arranged on one side of the electrolyte material, the cathode structure including a cathode electrode and a cathode current collector; and
an anode structure arranged on an opposite side of the electrolyte material from the cathode structure, the anode structure including:
an anode current collector;
a lithium metal anode arranged on a side of the anode current collector arranged facing the electrolyte material; and
a protective coating deposited on a surface of the lithium metal anode and arranged facing the electrolyte material, wherein the protective coating extends beyond the lithium metal anode and onto the anode current collector to seal both a surface and edge regions of the lithium metal anode from contact with a liquid electrolyte of the electrolyte material.

2. The lithium cell of claim 1, wherein the lithium metal anode is formed into separate segments along the anode current collector, the protective coating sealing edges of the lithium metal anode segments between adjacent segments of the lithium metal anode.

3. The lithium cell of claim 1, wherein the lithium metal anode is formed from a patterned deposition of material rather than from a foil.

4. The lithium cell of claim 1, wherein the protective coating comprises an inner layer and an outer layer, each layer being of a different coating material.

5. The lithium cell of claim 1, wherein the protective coating is formed by additive manufacturing.

6. The lithium cell of claim 1, wherein the protective coating comprises at least one polymer electrolyte layer including:
a base polymer material;
one or more lithium salts;
inorganic filler;
dispersant;
plasticizer;
auxiliary electrolyte;
an initiator; and
a rheology modifier.

7. The lithium cell of claim 1, wherein the protective coating includes at least one lithium alloy layer, the at least one lithium alloy layer serving as the lithium metal anode, and wherein the polymer electrolyte layer is deposited on the at least one lithium alloy layer.

8. The lithium cell of claim 1, wherein the protective coating includes at least one ceramic layer, the at least one ceramic layer being deposited on the lithium metal anode, and wherein the polymer electrolyte layer is deposited on the at least one ceramic layer.

9. The lithium cell of claim 1, wherein the protective coating comprises porous lithium nitride infused with composite polymer electrolyte.

10. The lithium cell of claim 9, wherein the infused composite polymer electrolyte comprises at least one of conductive carbon particles, conductive carbon fibers, or metallic powder.

11. The lithium cell of claim 1, wherein the protective coating comprises porous lithium fluoride infused with composite polymer electrolyte.

12. The lithium cell of claim 1, wherein the lithium metal anode comprises separate lithium segments arranged in an array pattern on the anode current collector, wherein the protective coating adheres directly to the anode current collector between the separate lithium segments and extends over and beyond the pattern of the separate lithium segments to seal the surface and the edge regions of the separate lithium segments from contact with the liquid electrolyte of the electrolyte material.

13. The lithium cell of claim 12, wherein x and y dimensions of the lithium segments can be in a range of 20 μm to 20 mm and space between the segments can be in a range of 10 to 200 μm.

14. A method of providing a protective coating on a lithium metal anode, the method comprising:
forming a lithium anode electrode on an anode current collector, the anode current collector being a substrate providing support for the lithium anode electrode; and
forming a protective coating over the lithium anode electrode, the protective coating extending beyond edges of the lithium anode electrode and onto surrounding portions of the anode current collector;
wherein both edge and surface regions of the lithium anode electrode are covered by the protective coating to prevent contact with a liquid electrolyte.

15. The method of claim 14, wherein forming the protective coating comprises additive manufacturing to deposit material of the protective coating over the lithium anode electrode.

16. The method of claim 14, wherein forming the protective coating comprises:
forming an inner layer of protective coating on the lithium anode electrode; and
forming an outer layer of protective coating over the inner layer on the lithium anode electrode, the inner and outer layers of protective coating being of different materials.

17. The method of claim 16, further comprising using additive manufacturing to form both the inner and outer layers of protective coating.

18. The method of claim 14, wherein forming the lithium anode electrode does not involve using a lithium foil, but includes a patterned deposition of anode material.

19. The method of claim 14, wherein forming the lithium anode electrode comprises using a slurry or evaporation technique.

20. The method of claim 14, wherein forming the protective coating comprise:
combining a base polymer material, one or more lithium salts, inorganic filler, dispersant, plasticizer, a polymerization initiator, auxiliary non-flammable electrolyte and a rheology modifier in a solvent to form a precursor polymer electrolyte composition;
depositing the precursor polymer electrolyte composition on a surface of the lithium metal anode; and
irradiating the precursor polymer electrolyte composition with an ultraviolet (UV) light for a predetermined length of time to dry and cure the precursor polymer electrolyte composition to form a polymer electrolyte protective coating on the surface of the lithium metal anode.

21. The method of claim 20, wherein depositing the precursor polymer electrolyte composition comprises using an additive manufacturing printhead to deposit the precursor polymer electrolyte composition on the surface of the lithium metal anode.

22. The method of claim 14, wherein forming the protective coating comprises:
forming a porous lithium nitride structure or porous lithium fluoride structure on the lithium anode electrode; and
infusing the porous lithium nitride or lithium fluoride structure with composite polymer electrolyte.

23. The method of claim 14, wherein forming a protective coating over the lithium anode electrode comprises:
forming the lithium metal anode comprising separate lithium segments arranged in an array pattern on the anode current collector, wherein the protective coating adheres directly to the anode current collector between the separate lithium segments and extends over and beyond the pattern of the separate lithium segments to seal the surface and the edge regions of the separate lithium segments from contact with the liquid electrolyte of the electrolyte material.

24. The method of claim 23, wherein x and y dimensions of the lithium segments can be in a range of 20 μm to 20 mm and space between the segments can be in a range of 10 to 200 μm.

25. A method of providing a protective coating on a lithium metal anode, the method comprising:
forming a lithium anode electrode on an anode current collector, the anode current collector being a substrate providing support for the lithium anode electrode; and
using a selective deposition additive manufacturing system, depositing a protective coating over the lithium anode electrode according to an electronic data model of the coating, the protective coating extending beyond edges of the lithium anode electrode and onto surrounding portions of the anode current collector;
wherein both edge and surface regions of the lithium anode electrode are covered by the protective coating to prevent contact with a liquid electrolyte.

26. The method of claim 25, wherein forming the protective coating comprises:
forming an inner layer of protective coating on the lithium anode electrode; and
forming an outer layer of protective coating over the inner layer on the lithium anode electrode, the inner and outer layers of protective coating being of different materials.

27. The method of claim 25, wherein forming the lithium anode electrode does not involve using a lithium foil, but includes a patterned deposition of anode material including using a slurry or evaporation technique.

28. The method of claim 25, further comprising:
combining a base polymer material, one or more lithium salts, inorganic filler, dispersant, plasticizer, a polymerization initiator, auxiliary non-flammable electrolyte and a rheology modifier in a solvent to form a precursor polymer electrolyte composition;
depositing the precursor polymer electrolyte composition on a surface of the lithium metal anode as the protective coating; and
irradiating the precursor polymer electrolyte composition with an ultraviolet (UV) light for a predetermined length of time to dry and cure the precursor polymer electrolyte composition to form a polymer electrolyte protective coating on the surface of the lithium metal anode.
